(19) United States
(12) Patent Application Publication
(10) Pub. No.: US 2007/0241887 A1
(43) Pub. Date: Oct. 18, 2007

(54) Buoyant tracking device and method of manufacture

(76) Inventors: Patrick E. Bertagna, Los Angeles, CA (US); James H. Cohen, Glendale, CA (US)

Correspondence Address: HENNEMAN & ASSOCIATES, PLC, 714 W. MICHIGAN AVENUE, THREE RIVERS, MI, 49093, US

(21) Appl. No.: 11/402,195

(22) Filed: Apr. 11, 2006

(51) Int. Cl. G08B 1/08; G08B 23/00

(52) U.S. Cl. 340/539.13; 340/573.6

(57) ABSTRACT

A personal safety device includes a buoyant component and a tracking device coupled to the buoyant component. The tracking device includes a location determining device and a wireless communication device. The wireless communication device is configured to communicate with a terrestrial communication network such as a cell phone network. The wireless communication device is effective in coastal and inland waters, and the reduced size as compared with satellite telephones makes the device practical use during recreational water activities. Various buoyant components including personal floatation devices, waterproof containers, and gas trapping encapsualtions are disclosed.

### BACKGROUND OF THE INVENTION

1. Field of the Invention

This invention relates generally to personal tracking devices, and more particularly to a personal tracking device having a buoyant component. Even more particularly, the invention relates to a personal tracking device in combination with a personal flotation device (PFD).

2. Description of the Background Art

Tracking devices embedded in personal flotation devices (PFDs) are known in the art. These devices are typically used in emergencies as a means to locate persons who are lost at sea, or have become separated from their vessel.

A problem with some prior art tracking devices is that they require mechanical activation by the user. However, in an emergency situation, a user may not be able to activate the device due to injury, unfamiliarity with the operation of the device, or some other reason. To address this problem, devices with automatic trigger mechanisms have been developed.

One such device is described in U.S. Pat. No. 6,439,941 (McClure et al.). The device of McClure et al. is a controller based device that includes a GPS receiver, a satellite radio-telephone, and a trigger mechanism. Upon activation of the trigger mechanism, the GPS receiver determines the current position of the device and transmits a distress signal including the determined position to a rescue organization such as the Coast Guard.

The device of McClure et al. has several disadvantages. For example, the device of McClure et al. relies on a trigger mechanism. In particular, a hydrostatic pressure detector triggers the activation of the device when the pressure detector senses a minimum specified submersion of the device for a specified duration. Further, the device deactivates when removed from the water, and the controller ceases transmission. This system relies on electronics for triggering activation, and may become deactivated or simply not activate if the hydrostatic pressure detector is faulty or not sufficiently submerged. This could be problematic if the wearer is not in the water. Conversely, if a tracking PFD not being worn were inadvertently lost from a vessel a false alarm could be triggered, and rescuers would waste valuable time searching for the PFD.

Another disadvantage is that the device of McClure et al. is relatively heavy and bulky and is, therefore, impractical for the average recreational user. The size and weight are due at least in part to the batteries and satellite radio-telephone, which are required to be functional on the open sea. As many boaters, jet-skiers, and water sports participants will understand, the overall size and weight of their PFD is extremely important to their comfort and ability to perform many activities such as waterskiing, wakeboarding, tubing, and so on. The device of McClure et al. is simply too large and heavy to be comfortably used during most recreational water activities.

The PFD of McClure et al. is also impractical for use in water sports activities, because the GPS receiver and satellite radio-telephone are activated when the hydrostatic pressure detector is submerged in water. Therefore, the PFD could not be used by water sports participants, because many water sports activities such as wakeboarding or waterskiing require the participant to be submerged in water at certain times. In those cases, the PFD would transmit an unintended distress signal.

Yet another problem associated with the device of McClure et al., as well as other prior art devices, is that users may elect not to wear bulky or uncomfortable PFDs. If the user is not wearing the tracking PFD, the device may be ineffective. For example, if a user became separated from the tracking PFD during an accident, then the user could not be tracked. As another example, if the user fell overboard, but the PFD remained on the vessel, then the device would not be activated.

Another problem with prior art tracking PFDs is that the tracking mechanisms may be susceptible to damage from shocks and impacts routinely encountered in high speed water sports. Known devices were simply never intended to be subjected to such shocks and impacts. Rather, the devices were primarily intended to facilitate rescue at sea.

In view of the problems with the prior art, what is needed is a PFD with a tracking device that does not require a trigger for activation of the tracking device. What is also needed is a PFD with a tracking device that does not generate false alarms when the wearer is intentionally in the water. What is also needed is a PFD with a tracking device that is operational even when the wearer is not in the water. What is also needed is a PFD with a tracking device that is smaller in size and lighter in weight. What is also needed is a PFD with a tracking device that is practical for use when participating in recreational water sports. What is also needed is a PFD with a tracking device that facilitates tracking of the user when the PFD is not being worn by the user.

### SUMMARY

One aspect of the present invention overcomes some or all of the above-described problems associated with the prior art by combining a tracking device with a buoyant component (e.g., a wearable PFD, waterproof canister, buoyant encapsulation). The size and weight of the device are minimized by using a terrestrial based wireless communication device (e.g., a cell phone modem) as opposed to a satellite radio-phone. The inventors have realized that eventhough the wireless communication device would be out of range on the open seas, the device can be effectively utilized in coastal and inland waters, where a significant amount of recreational water activities occur.

The present invention includes a buoyant component and a tracking device coupled to the buoyant component. The tracking device includes a location determining device and a wireless communication device electronically coupled to the location determining device. The wireless communication device (e.g., a cell phone modem) is configured to communicate with a terrestrial communication network (e.g., cellular network) to facilitate transmission of location data to a remote station. Optionally, the terrestrial communication network is exclusively land based.

The tracking device further includes a communication antenna and a location signal antenna. The communication antenna is electrically coupled to the wireless communication device. The location signal antenna is electrically coupled to the location determining device. In the embodiments shown, the communication antenna and location signal antenna are omni-directional antennas, but other types of antennas could be used instead. In one embodiment, both the location signal antenna and the communication antenna are disposed within the encapsulated tracking device.

In normal operation, the wireless communication device periodically transmits position information from the position determining device regardless of the existence of an emergency situation. The position determining device determines the position of the tracking device using signals transmitted by a positioning system (e.g., a satellite GPS system). Alternatively, the location determining system obtains information indicative of the position of the tracking device exclusively via the wireless communication device.

In a particular embodiment, the buoyant component is a PFD. The tracking device is detachably coupled to the PFD and is functional even when detached form the PFD. Means for detachable coupling the tracking device to the PFD include, but are not limited to, a clip, a lanyard, VELCRO®, a pocket, and so on. The PFD optionally includes built-in auxiliary or redundant components (e.g., batteries, antenna, charging connector, and so on) for use with the detachable tracking device. In one particular embodiment, a flexible circuit substrate is disposed beneath the outer fabric layer of a PFD and extends from a pocket of the PFD to the desired antenna locations, for example the upper shoulder section of the PFD. The tracking device includes a connector for connecting to the flexible circuit substrate when the tracking device is placed within the pocket of the PFD. Optionally, a cover or rubber cap sewn on to the outer material layer of the PFD provides additional protection for the antennas and any charging connector.

In another embodiment, the buoyant component is formed integrally with the tracking device. The tracking device is encapsulated in a waterproof material (e.g., a polyamide resin). The encapsulating waterproof material defines a slot to facilitate the insertion of a memory device (e.g., a Subscriber Identification Module or SIM card) to uniquely identify the wireless communication device. The slot is sealed (e.g., by adhesive, removable plug, etc.) after the memory device is inserted. In addition, the waterproof material defines at least one internal chamber containing a gas (e.g., encapsulated air pockets). Alternatively, the waterproof material is itself buoyant. In either case, the encapsulation serves as a buoyant component, such that the tracking device is also buoyant in water even when detached from the PFD.

The encapsulating material also defines a slot for receiving a battery. The wireless communication device is mounted on a circuit board that has a battery connector mounted thereon. The encapsulating material encapsulates a first portion of the battery connector that is connected to the circuit board and leaves a second portion on the connector exposed to facilitate connection to the battery. The battery receiving slot guides the battery into engagement with the battery connector. Optionally, the battery slot can be sealed once the battery is inserted therein. In alternative embodiments, the battery is non-removable, and included within the encapsulation material of the encapsulated tracking device.

In another embodiment, the buoyant component is a watertight container designed to receive the tracking device. In the particular embodiment shown, the container includes a primary vessel and a hinged lid. In addition, the container includes auxiliary components including, but not limited to, a power source, an antenna, and a charging connector. The lid traps air within the vessel so that the container is buoyant when the tracking device and the auxiliary components are enclosed therein. The disposition of the tracking device, the auxiliary components, and the trapped air within the container is such that the antenna(s) of the tracking device are disposed near the top of the container when the container is floating.

A safety system utilizing a tracking device of the present invention is also disclosed. The safety system includes a terrestrial based wireless communication network, a buoyant tracking device, and a tracking system. The buoyant tracking device connects wirelessly to the communication network. The tracking system is configured to receive location data from the tracking device via the wireless communication network.

A method for manufacturing a personal safety device is also disclosed. The method includes providing a buoyant component, providing a tracking device having a wireless communications device configured to communicate via a terrestrial communications network, and coupling the tracking device to the buoyant component (e.g., removably placed within a pocket, permanently embedded within the buoyant component, and so on).

### BRIEF DESCRIPTION OF THE DRAWINGS

The present invention is described with reference to the following drawings, wherein like reference numbers denote substantially similar elements:

FIG. 1 is a block diagram of a tracking system;

FIG. 2 is a front view of a PFD with a tracking device coupled thereto for use with the tracking system 100 of FIG. 1;

FIG. 3A is a front view of the tracking device of FIG. 2;

FIG. 3B is a side view of the tracking device of FIG. 3A;

FIG. 4A is a side view of a container for use with the tracking device of FIG. 2, when the tracking device is removed from the PFD;

FIG. 4B is a side cross-sectional view of the container of FIG. 4A, with the tracking device of FIG. 2 disposed therein;

FIG. 5 is a partially cut-away front view of an alternate PFD with an embedded tracking device disposed therein;

FIG. 6 is a front view of another alternative PFD with auxiliary components for use with a removable tracking device;

FIG. 7 is a partially cut-away front view of the PFD of FIG. 6 showing the tracking device and auxiliary components;

FIG. 8A is a front view of the tracking device of FIG. 6;

FIG. 8B is a side view of the tracking device of FIG. 6;

FIG. 9A is a side view of a container for use with the tracking device, when the tracking device is removed from the PFD of FIG. 6;

FIG. 9B is a cross-sectional view of the container of FIG. 9A, with the tracking device of FIGS. 8A-8B disposed therein;

FIG. 10 is a flowchart summarizing a method for manufacturing a buoyant tracking device.

### DETAILED DESCRIPTION

The present invention overcomes problems associated with the prior art, by providing a tracking device coupled to a buoyant component. The tracking device includes a wireless communication device configured to communicate via a terrestrial based network (e.g., a cell phone network). The tracking device can be conveniently attached to wearable PFDs and other buoyant components, because of the device's relatively small size as compared to a satellite telephone. In the following description, numerous specific details are set forth (e.g., particular electronic components, particular buoyant components, etc.) in order to provide a thorough understanding of the invention. Those skilled in the art will recognize, however, that the invention may be practiced apart from these specific details. In other instances, details of well known PFD manufacturing and electronics assembly practices and components have been omitted, so as not to unnecessarily obscure the present invention.

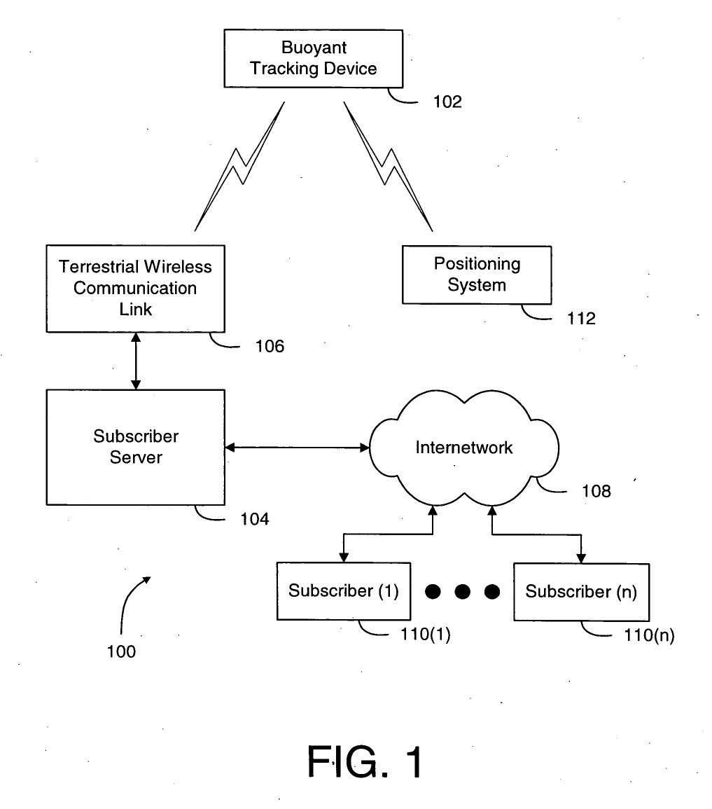

FIG. 1 is a block diagram of a tracking system 100 including a buoyant tracking device 102. Tracking system 100 further includes a subscriber server 104, a terrestrial wireless communication link 106, an internetwork 108, one or more subscribers 110(1-n), and a positioning system 112.

Tracking device 102 communicates wirelessly with subscriber server 104 via terrestrial wireless communication link 106. In the particular embodiment described, terrestrial wireless communications link 106 is a mobile telephone network. However, the invention is not limited to use with any particular type of mobile telephone network. Indeed, terrestrial wireless communication link 106 represents any means of wireless communication, now known or yet to be discovered, that facilitates communication between tracking device 102 and subscriber server 104 including, but not limited to cellular networks (e.g., CDMA and GSM), WIFI networks, and radio communication, so long as the communication network is terrestrially based.

Subscriber server 104 receives data from tracking device 102 indicative of the geographic position of tracking device 102, and provides the information to subscribers 110(1-n) via internetwork 108. In this particular embodiment of the invention, internetwork 108 is the Internet. However, any suitable means of communication between subscriber server 104 and subscriber servers 110(1-n) can be used for internetwork 108.

Subscribers 110(1-n) represent individuals with an interest in the location of the person wearing tracking device 102. For example tracking system 100 can be used by emergency service personnel to locate boaters in distress, by remote data logging devices to provide periodic location tracking logs for users, and so on. Subscribers 110(1-n) communicate with subscriber server 104 via internetwork 108 using some sort of client device including, but not limited to, a personal computer, a telephone, and so on.

Responsive to a command from subscriber server 104, tracking device 102 determines its location using location signals received from positioning system 112 and transmits data indicative of the determined system back to subscriber server 104. Positioning system 112 represents any type of satellite or terrestrial based positioning system that transmits signals that can be used to determine location. For example, a global positioning system (GPS) currently in use employs a plurality of satellites that continuously transmit signals. GPS receivers can calculate location by determining the difference in the time of receipt of signals from different satellites. GPS technology is well known, and so will not be described in detail herein.

As an alternative to a GPS type system, positioning system 112 can be incorporated into terrestrial wireless communication link 106. For example, wireless telephone networks now have the capability of determining the location of mobile telephone handsets based on signals from a plurality of signal towers in the network. Terrestrial wireless communication link 106 can then provide the determined location directly to tracking device 102, which in turn can communicate the location to subscriber server 104. As a result, positioning system 112 can be thought of as either optional or as being incorporated into terrestrial wireless communication link 106.

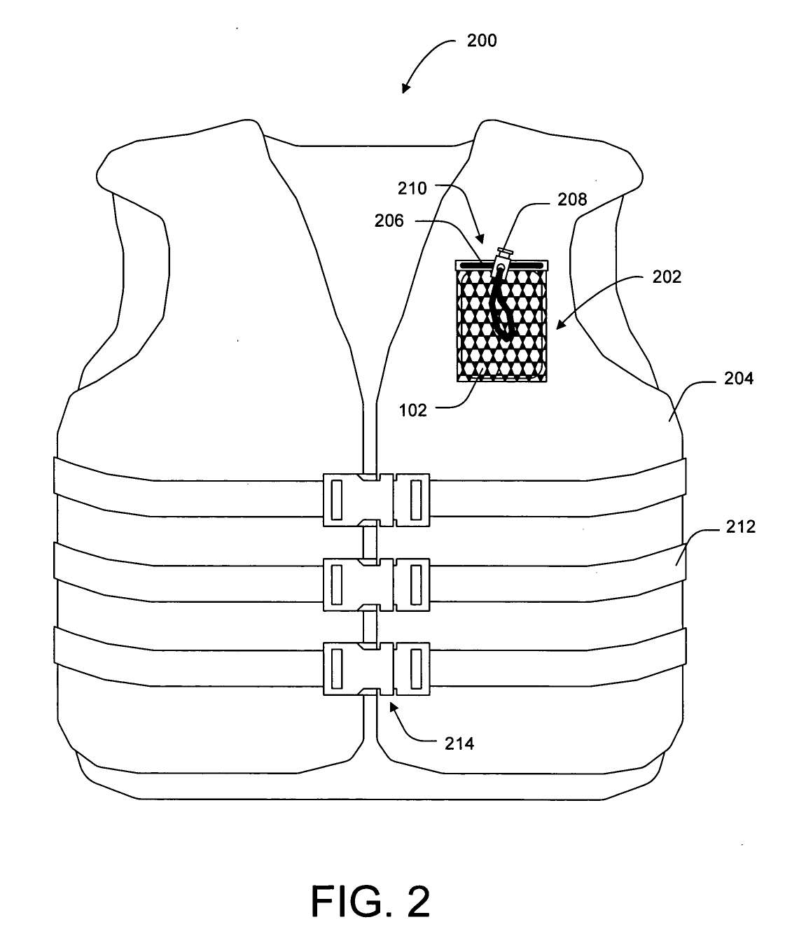

FIG. 2 is a front view of tracking device 102 coupled to a buoyant component 200. In this particular embodiment, buoyant device 200 is a wearable personal flotation device (PFD). Tracking device 102 is removably disposed in a pocket 202 on the outer surface 204 of PFD 200. Pocket 202 is a mesh pocket that is fastened to the outer surface 204 of buoyant device 200 in the upper chest or shoulder region and includes an opening 210 generally located at the top of pocket 202. Pocket 202 further includes an elastic cord 206 and clasp 208 that in combination, allow for tightening and loosening of pocket opening 210. The tightening and loosening of pocket opening 210 allows tracking device 102 to be inserted or removed from PFD 200.

Pocket 202 does not penetrate the inner chamber of PFD 200. Therefore, pocket 202 and tracking device 102 should not adversely impact the buoyancy or life preserving functionality of PFD 200. This is an advantage, because tracking device 102 and pocket 202 can be incorporated into existing PFD designs without adversely affecting the approval (e.g., Coast Guard approval) of those designs.

In this particular embodiment, PFD 200 includes three full wrapping straps 212, each having a two part fastener 214, to allow a user to easily put on or remove the PFD. Straps 212 and fasteners 214 are common to many wearable PFDs on the market today. The quantity and placement of straps 212, fasteners 214, and pocket 202 may vary according to the particular design of the PFD.

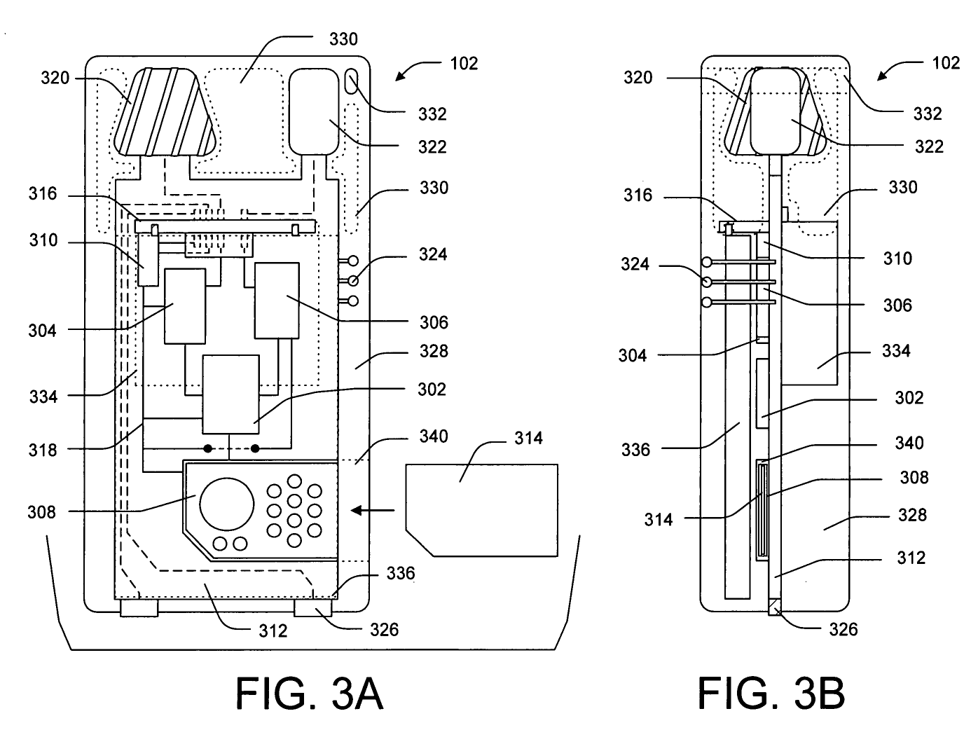

FIG. 3A is a front view of tracking device 102, which is shown to include a controller 302, a GPS receiver 304, a wireless modem 306, a SIM card socket 308, a power supply 310, all mounted on a circuit board 312. Controller 302 includes a processing unit and code, which when executed provides overall coordination and control of the various functions of tracking device 102 described herein. GPS receiver 304 is electrically coupled to GPS antenna 320. GPS receiver 304 processes location signals received via GPS antenna 320 and provides the current location of tracking device 102 to controller 302. Wireless modem 306 is electrically coupled to global system for mobile communications (GSM) antenna 322. Wireless modem 306 is able to establish a connection with subscriber server 104 via terrestrial wireless communication link 106, as described above with reference to FIG. 1. SIM card socket 308 is designed to receive a subscriber identification module 314, which includes data that uniquely identifies the card (e.g., a phone number) and facilitates access to terrestrial wireless communication link 106 (e.g., a wireless telephone network).

Power supply 310 is coupled to charging contacts 326 and is coupled to a battery 336 via a battery connector 316, which is also mounted on circuit board 312. Battery 336 is shown in phantom lines in FIG. 3A, so as not to obscure the view of the other components. When charging contacts 326 are connected to an external charger/power source, power supply 310 draws power from the external source and charges battery 336. During normal operation of tracking device 102, power supply 310 draws power from battery 336 and provides power to each component of tracking device 102, at whatever voltages are required by the particular components, via voltage supply lines 318. Although voltage supply lines 318 are shown as a single line, it should be understood that voltage supply lines 318 will include as many lines as necessary to satisfy the voltage/power requirements of the particular components.

An encapsulation material 328 encapsulates circuit board 312 and all of the components mounted thereon. With a few exceptions, encapsulation material 328 completely encapsulates tracking device 102. The first exception is a slot 340 that facilitates removal and reinsertion of SIM card 314 during initial activation. Once tracking device 102 is activated, slot 340 is sealed with an epoxy, a plug, or any other water tight means (not shown). The second exception to complete encapsulation of tracking device 102 is that a portion of battery connector 316 is left unencapsulated to facilitate the insertion and removal of battery 336. Optionally, battery 336 is completely and permanently encapsulated in tracking device 102. The third exception is that portions of charging contacts 326 are left unencapsulated to facilitate electrical contact with devices such as charging units or auxiliary batteries.

Tracking device 102 also includes indicator light emitting diodes (LEDs) 324, which are electrically coupled to circuit board 312 and functional to provide feedback to the user. Such feedback may include battery level, signal strength, communication status, and so on. In this particular embodiment, indicator LEDs 324 are switched by controller 302 and are operative to emit multi-colored light, blinking light, and so on, in order to display the necessary feedback to the user with the minimum number of LED lights.

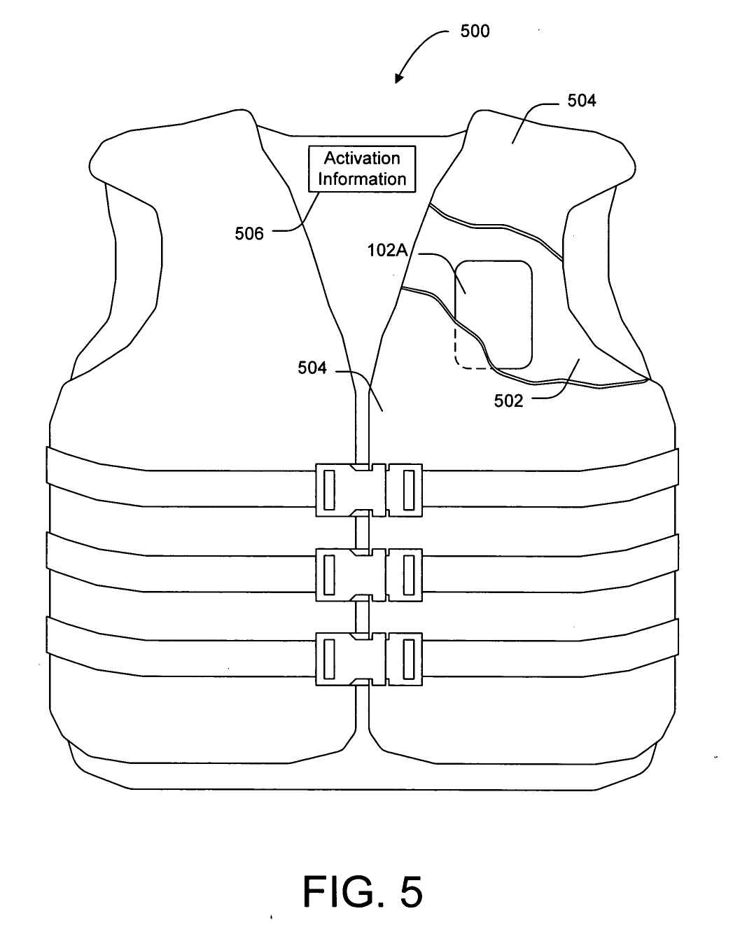

Also included in tracking device 102 is an inductive charging unit 334. Inductive charging unit 334 is an optional item, and may serve as an auxiliary or redundant charging source for tracking device 102. Inductive charging unit 334 is electrically coupled to power supply 310 and battery 336 in a similar manner to charging contacts 326 as previously described herein. Inductive charging unit 334 provides a means for charging tracking device 102 wirelessly and provides an advantage in embodiments where tracking device 102 is completely embedded in a PFD or other buoyant component. In such embodiments (e.g., FIG. 5), tracking device 102 can be charged even though it is inaccessible.

Encapsulation material 328 also provides buoyancy to tracking device 102. In particular, encapsulation material 328 defines internal gas chambers 330. Internal gas chambers 330 are simply chambers or voids formed in the encapsulation material 328 that contain a gas (e.g., air) to increase the buoyancy of tracking device 102. Chambers 330 are sufficiently large that tracking device 102 will float in water even when detached from PFD 200 (FIG. 2). In addition, because chambers 330 are disposed near the top of tracking device 102, GPS antenna 320 and GSM antenna 322 will remain upright when tracking device 102 is floating. Because encapsulation material 328 can cause tracking device 102 to float, encapsulation material 328 is also considered to be a buoyant component coupled to tracking device 102.

A hole 332 is defined by encapsulation material 328 to allow for the connection of a device such as a lanyard to aid in the carrying of tracking device 102 when it is separated from buoyant device 200.

FIG. 3B is a side view of the tracking device 102 of FIG. 3A. In FIG. 3B, hole 332 is shown to completely pass through the encapsulation material 328. Additionally, indicator LEDs 324 are shown to be just below the surface of encapsulation material 328, to ensure that they are visible to the user. Battery 336 is also shown in FIG. 3B, and is positioned on the same side of circuit board 312 as indicator LEDs 324. Inductive charging unit 334 is disposed on the opposite side of circuit board 312.

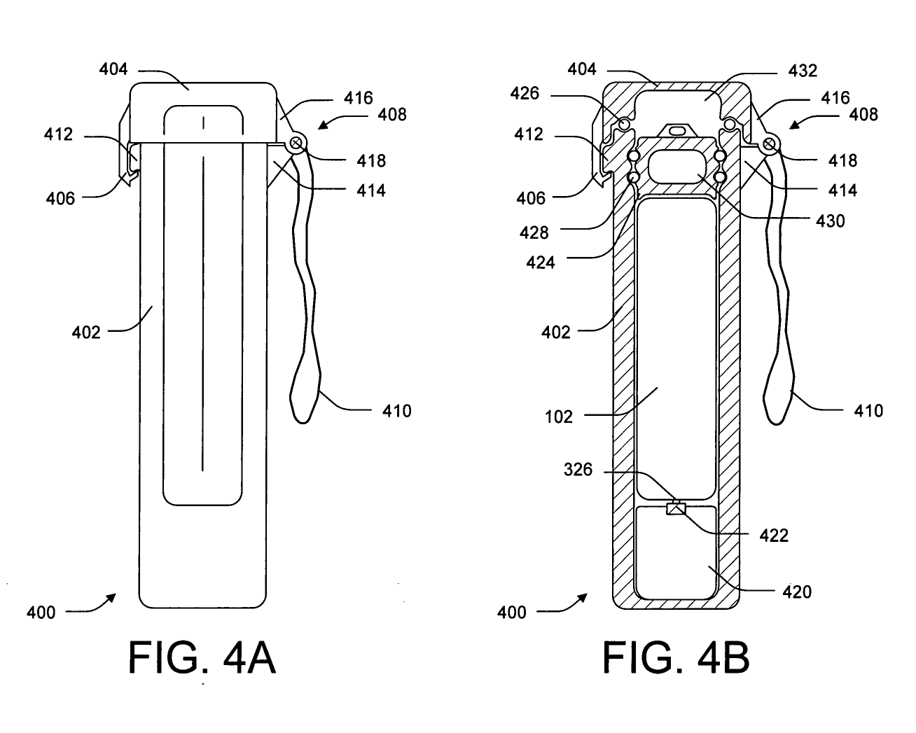

FIG. 4A is a side view of a container 400 for use with tracking device 102 when tracking device 102 is separated from buoyant device 200 of FIG. 2. Container 400 includes a body 402, a lid 404, a latch 406, a hinge 408, and a carrying strap 410. Container 400 is a waterproof, buoyant container, and is constructed of a non-corrosive material such as plastic. Body 402 of container 400 is shaped to receive and hold tracking device 102 snuggly therein. Body 402 also includes a protrusion 412 for engaging latch 406.

Lid 404 of container 400 includes an integrally formed latch 406. Lid 404 fits tightly over the opening of body 402 and is secured in place by latch 406 engaging protrusion 412. When latch 406 is properly secured over protrusion 412, a watertight seal is formed between lid 404 and body 402 of container 400, as will be described in greater detail below.

Hinge 408 is a three part hinge comprising a first portion 414, a second portion 416, and a hinge pin 418. First portion 414 of hinge 408 is an integral part of body 402 of container 400. Likewise, second portion 416 of hinge 408 is an integral part of lid 404. First portion 414 and second portion 416 of hinge 408 have complementary surfaces with a central aperture for receiving hinge pin 418. When hinge pin 418 is inserted through first portion 414 and second portion 416 of hinge 408, and secured in place, lid 404 is pivotally mounted to body 402. Carrying strap 410 fits between first portion 414 and second portion 416 of hinge 408, and is attached to container 400 by hinge pin 418.

FIG. 4B is a side cross-sectional view of container 400 with tracking device 102 and an auxiliary battery 420 disposed therein. In this embodiment, auxiliary battery 420 is removable from container 400, but battery 420 could be permanently molded in the bottom of container 400. Auxiliary battery contacts 422 are positioned to engage charging contacts 326 of tracking device 102, and thereby provide auxiliary battery power to tracking device 102. Auxiliary battery contacts 422 are also used to charge auxiliary battery 420. Auxiliary battery 420 is charged by inserting a charging adapter (not shown) into container 400 instead of tracking device 102.

Contacts 326 of tracking device 102 are held in contact with auxiliary battery contacts 422 by a removable insert 424 that exerts downward pressure on tracking device 102. Insert 424 also provides an additional watertight seal for the cavity containing tracking device 102. Insert 424 includes o-rings 428 that fit tightly into complementary grooves on insert 424 and the body 402 of container 400, thereby holding insert 424 firmly in place. Insert 424 further includes an internal gas chamber 430 to provide additional buoyancy for container 400. Similarly, lid 404 traps air in the top of container also adding buoyancy to container 400 and making container 400 tend to float in an upright position.

FIG. 5 is a partially cut-away front view of an alternate PFD 500 having an alternate tracking device 102A completely embedded therein. In this embodiment, tracking device 102A is sewn into PFD 500 between an inner layer of fabric 502 surrounding the buoyant material of PFD 500 and an outer layer of material 504. Tracking device 102A is held in place by stitching (not shown) and/or an adhesive (also not shown).

Alternate tracking device 102A is not directly accessible by the user. Therefore, tracking device 102A is similar to tracking device 102, except for a few modifications. In particular, battery 336 and SIM card 314 need not be removable. As a result, tracking device 102A can be completely encapsulated in encapsulation material 324. Complete encapsulation provides an advantage in that there is less chance of water leakage into alternate tracking device 102A. Although inaccessible to the user, alternate tracking device 102A can be charged via inductive charger 334.

The inaccessibility of SIM card 314 is an issue when activating alternate tracking device 102A. Normally, during the activation of a cell phone type device, the SIM card must be removed in order to read identification information printed on the SIM card. Because SIM card 314 of alternate tracking device 102A is inaccessible, the required activation information is printed on a tag 506 fixed to PFD 500. Alternatively, the activation information can be provided on printed material sold with PFD 500.

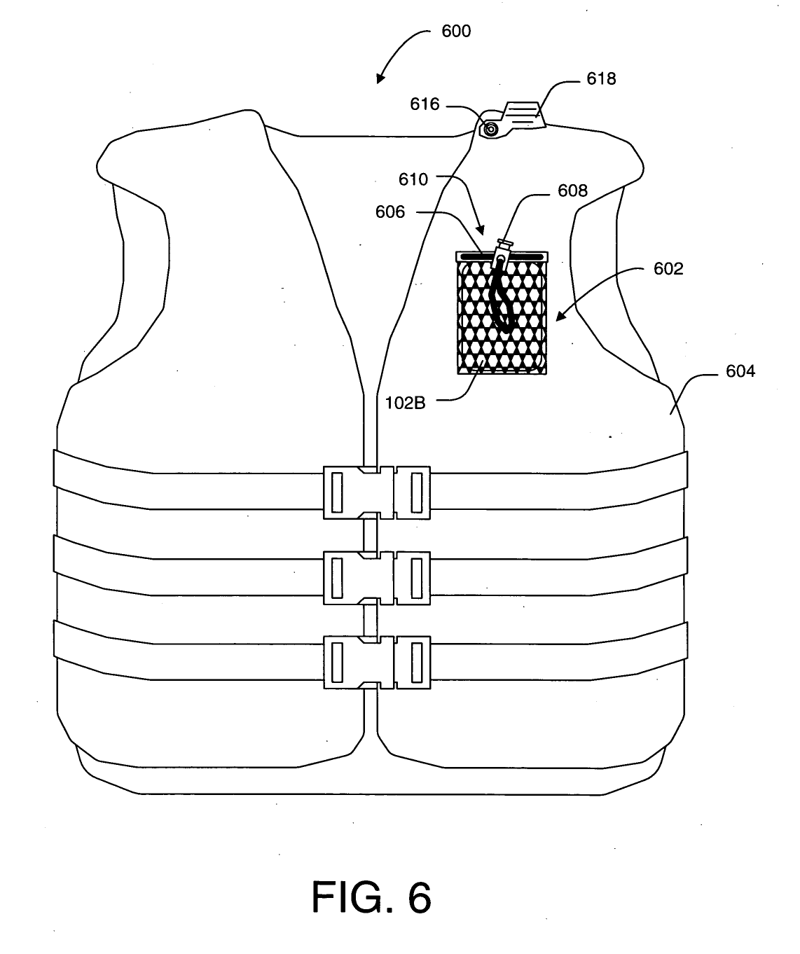

FIG. 6 is a front view of another alternate PFD 600, including another alternate tracking device 102B disposed in a pocket 602 of PFD 600. Pocket 602 is a mesh fabric fixed to the outer layer 604 of PFD 600 and includes an elastic cord 606 and a clasp 608 for securing an opening 610 into pocket 602.

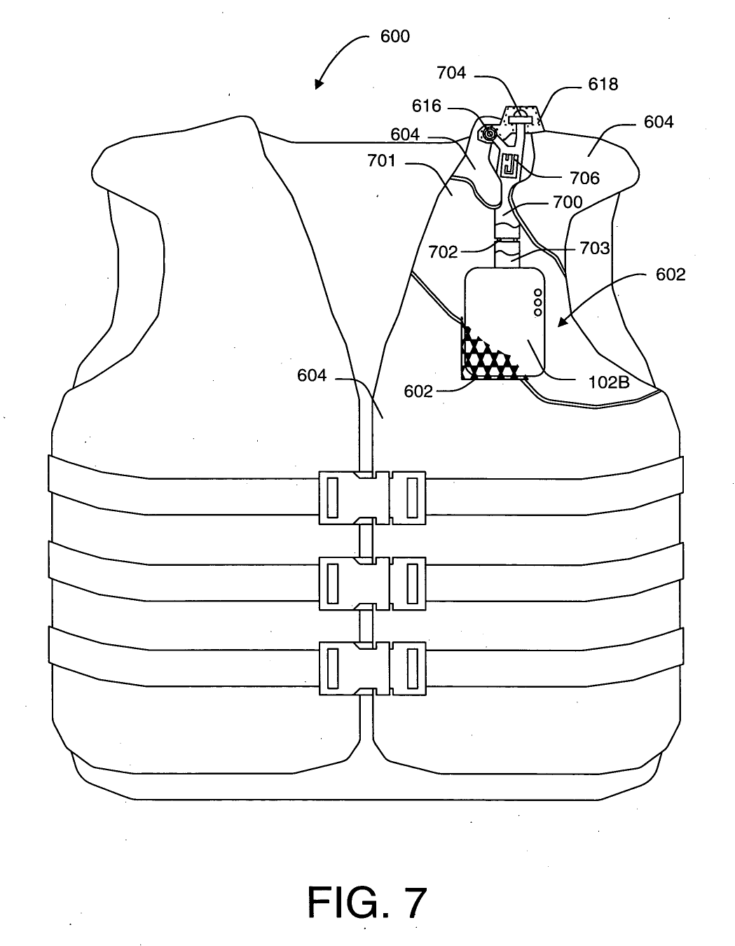

PFD 600 further includes permanently embedded auxiliary components. For example, a charging connector 616 and a protective cap 618 are visible in FIG. 6. Charging connector 616 is a waterproof connector that facilitates charging of alternate tracking device 102B when alternate tracking device 102B is coupled to PFD 600. Protective cap 618 is a rubber cap that is bonded or sewn to the outer surface 604 of PFD 600 to cover and protect one or more auxiliary antennas (FIG. 7). The types of auxiliary devices that can be attached to PFD 600 are limited to the example auxiliary devices shown. Rather, it is anticipated that many other types of auxiliary devices (e.g., indicator lights, batteries, solar charger, and so on) can be incorporated into PFD 600.

FIG. 7 is a partially cut-away front view of PDF 600 showing the electronic interconnection of alternate tracking device 102B and the auxiliary components. Charging connector 616 is connected to tracking device 102B via a flexible circuit substrate 700, which passes between outer layer 604 and an inner layer 701 of PFD 600. Inner layer 701 is an additional fabric layer below outer layer 604 and functions to separate the tracking device 102B and the auxiliary components from the buoyant materials disposed below inner layer 701. Flexible circuit substrate extends from the shoulder area near charging connector 616, through an opening (not shown) in outer layer 604, and into pocket 602.

Tracking device 102B connects to flexible circuit substrate as follows. Flexible circuit substrate 700 includes connectors 702 that connect to complementary connectors 702 on another portion of flexible circuit substrate 703 that extends from tracking device 102. In the view of FIG. 7, the connection between flexible circuit substrate 700 and flexible circuit substrate 703 is shown above tracking device 102B. However, as described above, flexible circuit substrate 700 is sufficiently long to extend into pocket 602. Tracking device 102B can, therefore, be connected and disconnected from flexible circuit substrate 700 within pocket 602, thereby facilitating easy removal and reconnection of tracking device 102B.

Flexible circuit substrate 700 further includes an auxiliary GPS antenna 704, and an auxiliary GSM antenna 706 mounted thereon. GPS antenna 704 and GSM antenna 706 are electrically coupled to tracking device 102 via flexible circuit substrate 700, connectors 702, and flexible circuit substrate 710. GPS antenna 704 and charging connector are housed within protective cap 618, which is bonded to outer surface 604 of PFD 600, as previously. A slit in outer layer 604, beneath protective cap 618, facilitates the passage of flexible circuit substrate 700 to GPS antenna 704 and charging connector 616.

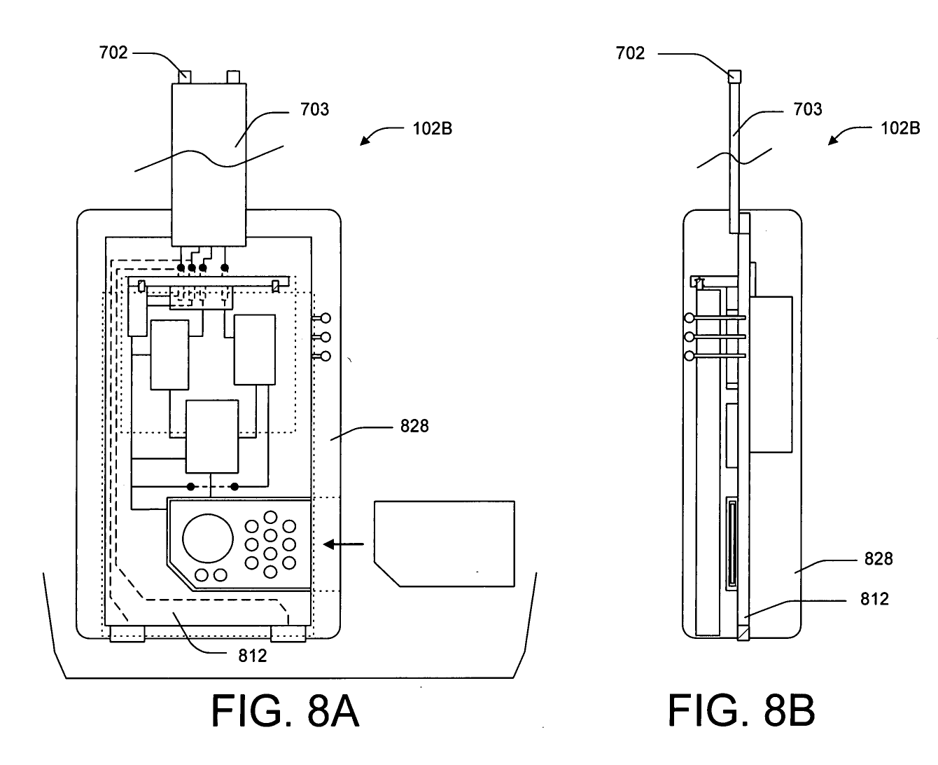

FIG. 8A is a front view of alternate tracking device 102B. Tracking device 102B is similar to tracking device 102 of FIG. 3A, except that GPS antenna 320, GSM antenna 322, internal gas chambers 330, and hole 332 have been omitted. GPS antenna 320 and GSM antenna 322 are replaced by flexible circuit substrate 703, which provides a connection to charging connector 616, GPS antenna 704, and GSM antenna 706, via connectors 702 and flexible circuit substrate 700, as described above with reference to FIG. 7.

In alternate tracking device 102B, flexible circuit substrate 703 is provided instead of antennas 320 and 322. This provides an advantage in that tracking device 102B is smaller, lighter, and less expensive to manufacture. However, it should be understood that flexible circuit substrate can be used in addition to antennas 320 and 322, so that the user has the option of using tracking device 102B with the auxiliary components of PFD 600 or as a detached, fully functional tracking device.

FIG. 8B is a side view of alternate tracking device 102B. Note that encapsulation material 828 completely surrounds flexible circuit substrate 703. Flexible circuit substrate is electrically connected to circuit board 812 prior to the encapsulation process. During the encapsulation process, encapsulation material 828 forms a water tight bond to flexible circuit substrate 703, thereby preventing any water leakage into tracking device 102B.

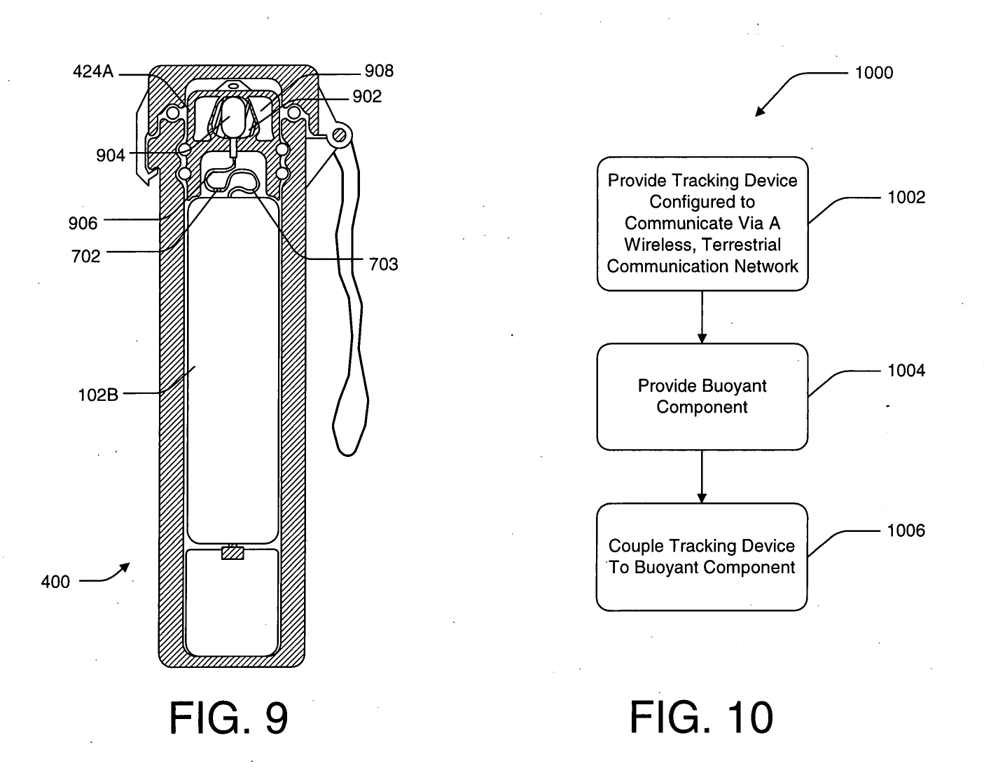

FIG. 9 is a side cross-sectional view of container 400, with alternate tracking device 102B disposed therein. In addition, container 400 includes an alternate removable insert 424A. Alternate insert 424A is similar to insert 424, except that insert 424A is modified to include a GPS antenna 902 and GSM antenna 904. Insert 424A also includes a flexible circuit substrate 906 to connect GPS antenna 902 and GSM antenna 904 to tracking device 102B via connectors 702 and flexible circuit substrate 703. Note also that insert 424A defines an internal chamber that traps air. Thus, container 400 provides buoyancy, auxiliary power, and auxiliary antennas for tracking device 102B. Indeed, container 400 can host other types of auxiliary devices including, but not limited to, light and sound emitting devices.

FIG. 10 is a flowchart summarizing a method 1000 for manufacturing a buoyant tracking device. In a first step 1002, a tracking device configured to communicate via a wireless terrestrial communication network is provided. Then, in a second step 1004, a buoyant component is provided. Next, in a third step 1006, the tracking device is coupled to the buoyant component.

The description of particular embodiments of the present invention is now complete. Many of the described features may be substituted, altered or omitted without departing from the scope of the invention. For example, some wireless communication devices (e.g., controller 302 and wireless modem 306) can obtain position information exclusively from the particular terrestrial wireless communication link 106 used, so the GPS components (receiver 304 and antenna 306) can be omitted. Alternatively, known assisted GPS systems can obtain accurate position information using a GPS signal or a partial GPS signal in combination with information (e.g., a time stamp) from the wireless communication link 106. As another example, a great variety of buoyant components may be substituted for the example buoyant components (wearable PFD, container, and encapsulation material). Examples of other such buoyant components include, but are not limited to, PFDs for pets, non-wearable PFDs such as throwable cushions, inflatable PFDs, floating keychains, floating garments such as hats, and so on.

Note also that the detachability aspect of the invention provides advantages in fields other than marine products. For example, tracking device 102 can be detachably coupled to other articles such as shoes and accessories (including, but not limited to, backpacks, suitcases, and briefcases). In one particular embodiment, tracking device 102 is carried in a pocket or pouch on the side of a shoe. Note that in the non-marine applications the tracking device need not be buoyant.

These and other deviations from the particular embodiments shown will be apparent to those skilled in the art, particularly in view of the foregoing disclosure.

We claim:

1. A personal safety device comprising:
a buoyant component; and
a tracking device coupled to said buoyant component, said tracking device including a location determining device and a wireless communication device electronically coupled to said location determining device, said wireless communication device being configured to communicate with a terrestrial communication network.

2. A personal safety device according to claim 1, wherein said tracking device is encapsulated in a waterproof material.

3. A personal safety device according to claim 2, wherein:
said waterproof material defines a slot to facilitate the insertion of a memory device into said wireless communication device; and
said slot is sealed after said memory device is inserted into said wireless communication device.

4. A personal safety device according to claim 2, wherein said waterproof material defines at least one internal chamber containing a gas, thus forming at least a portion of said buoyant component.

5. A personal safety device according to claim 1, wherein said terrestrial communications network is a cellular telephone network.

6. A personal safety device according to claim 1, wherein said terrestrial communications network is an exclusively land based network.

7. A personal safety device according to claim 1, wherein said wireless communication device periodically transmits position information from said position determining device regardless of the existence of an emergency situation.

8. A personal safety device according to claim 1, further comprising a watertight container for receiving said tracking device.

9. A personal safety device according to claim 8, wherein:
said tracking device is fully operational apart from said container; and
said container further includes at least one auxiliary component for use with said tracking device.

10. A personal safety device according to claim 9, wherein said auxiliary component is a power source.

11. A personal safety device according to claim 10, wherein said auxiliary component is an antenna.

12. A personal safety device according to claim 11, wherein said tracking device is buoyant apart from said container.

13. A personal safety device according to claim 9, wherein said container is buoyant when said tracking device and said auxiliary component are enclosed therein.

14. A personal safety device according to claim 1, wherein said buoyant component is a personal floatation device.

15. A personal safety device according to claim 14, wherein said tracking device is detachably coupled to said personal floatation device.

16. A personal safety device according to claim 15, wherein said tracking device is functional when detached from said personal floatation device.

17. A personal safety device according to claim 15, wherein said tracking device is buoyant in water when detached from said personal floatation device.

18. A personal safety device according to claim 14, wherein said personal floatation device includes at least one auxiliary component for use with said tracking device.

19. A personal safety device according to claim 18, wherein said auxiliary component is a power source.

20. A personal safety device according to claim 18, wherein said auxiliary component is an antenna.

21. A personal safety device according to claim 18, wherein said auxiliary component is a charging connector.

22. A personal safety device according to claim 1, wherein said location determining device obtains information indicative of a position of said tracking device exclusively via said wireless communication device.

23. A personal safety device according to claim 1, wherein said location determining device determines a position of said tracking device using signals transmitted by a positioning system.

24. A personal safety device according to claim 23, wherein said positioning system is a satellite based global positioning system.

25. A personal safety device according to claim 1, wherein said location determining device determines a position of said tracking device using signals transmitted by a positioning system in combination with information received from said terrestrial communication network.

26. A personal safety device comprising:
a personal floatation device;
a buoyant tracking device; and
means for detachably coupling said buoyant tracking device to said personal floatation device.

27. A method for manufacturing a personal safety device, said method comprising:
providing a buoyant component;
providing a tracking device having a wireless communications device configured to communicate via a terrestrial communications network; and
coupling said tracking device to said buoyant component.

28. A safety system comprising:
a terrestrial based wireless communication network;
a buoyant tracking device wirelessly connectable to said wireless communication network; and
a tracking system configured to receive location data from said tracking device via said wireless communication network.
